(19) United States
(12) Patent Application Publication
(10) Pub. No.: US 2008/0072673 A1
(43) Pub. Date: Mar. 27, 2008

(54) Portable testing system

(76) Inventor: Daniel J. Carnevale, Beverly, MA (US)

Correspondence Address: Mark J. Pandiscio, 470 Totten Pond Road, Waltham, MA, 02451-1914, US

(21) Appl. No.: 11/818,405

(22) Filed: Jun. 14, 2007

Related U.S. Application Data
(60) Provisional application No. 60/813,518, filed on Jun. 14, 2006.

(51) Int. Cl. G01N 29/00

(52) U.S. Cl. 73/602

(57) ABSTRACT

Apparatus for measuring the thickness of a material and alerting an operator when the thickness of a material is below a certain level, the apparatus comprising: a device for measuring the thickness of a material; a display screen for displaying the thickness of a material to the operator; and a device for alerting the operator when the thickness of the material is below a certain level. Apparatus for measuring the thickness of a material and alerting an operator when the thickness of a material is below a certain level, the apparatus comprising: a device for measuring the thickness of a material; a display screen for displaying the thickness of a material to the operator; and a device for alerting the operator when the thickness of the material is below a certain level, wherein the operator is alerted by a vibration alarm. Apparatus for indicating when a transducer needs to be replaced, the apparatus comprising: apparatus for measuring the wear of a transducer; a display screen for displaying the wear of a transducer to the operator; and an alarm for alerting an operator that the wear of the transducer is below a certain level, thereby indicating to the operator that the transducer needs to be replaced. A handheld apparatus with a user interface which can be controlled by a left-handed or right-handed operator, the handheld apparatus comprising: a display screen for displaying a set of parameters for an operator; wherein, for a left-handed operator, the set of parameters are displayed on the display screen in a way that is practical for the left-handed operator and for a right-handed operator, the set of parameters are displayed on the display screen in a way that is practical for the right-handed operator.

### REFERENCE TO PENDING PRIOR PATENT APPLICATION

This patent application claims benefit of pending prior U.S. Provisional Patent Application Ser. No. 60/813,518, filed Jun. 14, 2006 by Daniel J. Carnevale et al. for IMPROVED PORTABLE TESTING SYSTEM (Attorney's Docket No. DANA-567A PROV).

The above-identified patent application is hereby incorporated herein by reference.

### FIELD OF THE INVENTION

The following describes an improved portable testing system which includes four unique elements which are incorporated in our new ultrasonic devices, and which may be incorporated in other portable devices requiring (i) sensing of probe wear, and/or (ii) use of illumination of a keypad to alert the operator of a go-no-go condition, and/or (iii) use of vibralarm to alert the operator of a go-no-go condition, and/or (iv) devices meant to be held in either the left or right hand.

### BACKGROUND OF THE INVENTION

Ultrasonic devices (e.g., transducers) may be used to measure a parameter of interest such as the flow rate of a fluid within a conduit, the density of a liquid or gas, or the thickness of a sheet of metal. In order to calculate the desired property with the ultrasonic device, a pulse or ultrasonic wave is passed through the material. The ultrasonic device then receives a portion of the pulse or ultrasonic wave after it has traveled through the material and the desired parameters may then be calculated.

For convenience and ease of measuring different materials, many of the current ultrasonic devices are portable devices. However, there are several problems associated with the current ultrasonic devices.

First, over time, ultrasonic devices may lose their sensitivity and thus, provide inaccurate or unstable readings. Current portable ultrasonic devices do not include a system for measuring the wear of the device and reporting the same to the user. Thus, the user has no reliable indication that the ultrasonic device is not providing an accurate reading.

Second, ultrasonic devices may be set to indicate whether or not a certain property of a material is sufficient for its intended use (e.g., measuring the thickness of a pipe carrying a pressurized liquid). While some current ultrasonic devices comprise alarms for alerting a user that the material is insufficient, many ultrasonic devices are used in noisy industrial settings which make it difficult for a user to hear an alarm.

Third, portable ultrasonic devices require the flexibility of holding the device in the right hand or the left hand. Current ultrasonic devices do not provide a single device which can easily be set up for a right-handed or left-handed user.

### SUMMARY OF THE INVENTION

Thus, in one form of the invention, our new ultrasonic devices incorporate four novel features:

(1) an Auto Transducer wear indicator;

(2) LED's to light up the keypad on alarm condition;

(3) vibralarm to vibrate the ultrasonic device on alarm condition; and/or

(4) a Programmable Lefty/Righty soft keys user interface.

As used herein, the term “vibralarm” is a proprietary term meant to refer to a vibration alarm, wherein the ultrasonic device is configured to vibrate in a fashion so as to alert the operator.

In one form of the invention, there is provided apparatus for measuring the thickness of a material and alerting an operator when the thickness of a material is below a certain level, the apparatus comprising:

a device for measuring the thickness of a material;

a display screen for displaying the thickness of a material to the operator; and

a device for alerting the operator when the thickness of the material is below a certain level.

In another form of the invention, there is provided apparatus for measuring the thickness of a material and alerting an operator when the thickness of a material is below a certain level, the apparatus comprising:

a device for measuring the thickness of a material;

a display screen for displaying the thickness of a material to the operator; and

a device for alerting the operator when the thickness of the material is below a certain level, wherein the operator is alerted by a vibration alarm.

In another form of the invention, there is provided apparatus for indicating when a transducer needs to be replaced, the apparatus comprising:

apparatus for measuring the wear of a transducer;

a display screen for displaying the wear of a transducer to the operator; and

an alarm for alerting an operator that the wear of the transducer is below a certain level, thereby indicating to the operator that the transducer needs to be replaced.

In an additional form of the invention, there is provided a handheld apparatus with a user interface which can be controlled by a left-handed or right-handed operator, the handheld apparatus comprising:

a display screen for displaying a set of parameters for an operator;

wherein, for a left-handed operator, the set of parameters are displayed on the display screen in a way that is practical for the left-handed operator and for a right-handed operator, the set of parameters are displayed on the display screen in a way that is practical for the right-handed operator.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIG. 1 shows an ultrasonic device in use;

FIG. 2 is a diagram illustrating the results of an ultrasonic device measuring wear;

FIG. 3 illustrates an ultrasonic device of the present invention;

FIGS. 4-6 show various user interfaces of an ultrasonic device of the present invention;

FIG. 7 illustrates an ultrasonic device of the present invention;

FIG. 8 illustrates an ultrasonic device of the present invention; and

FIGS. 9-16 show various user interfaces of an ultrasonic device of the present invention.

### DETAILED DESCRIPTION OF THE PRESENT INVENTION

### (1) The Auto Transducer Wear Indicator

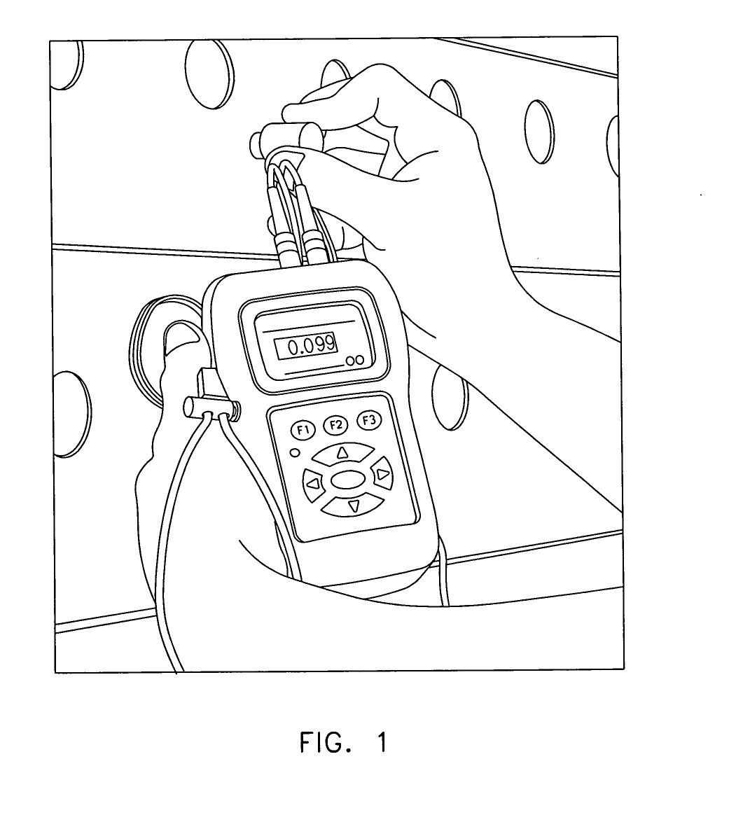

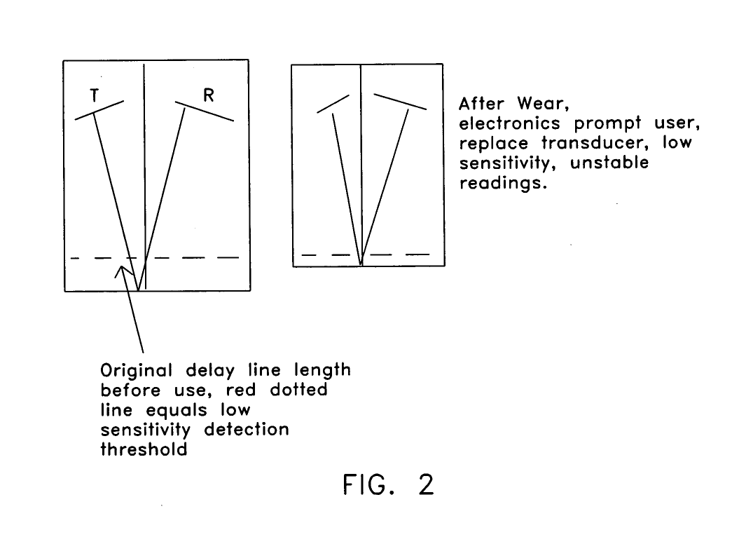

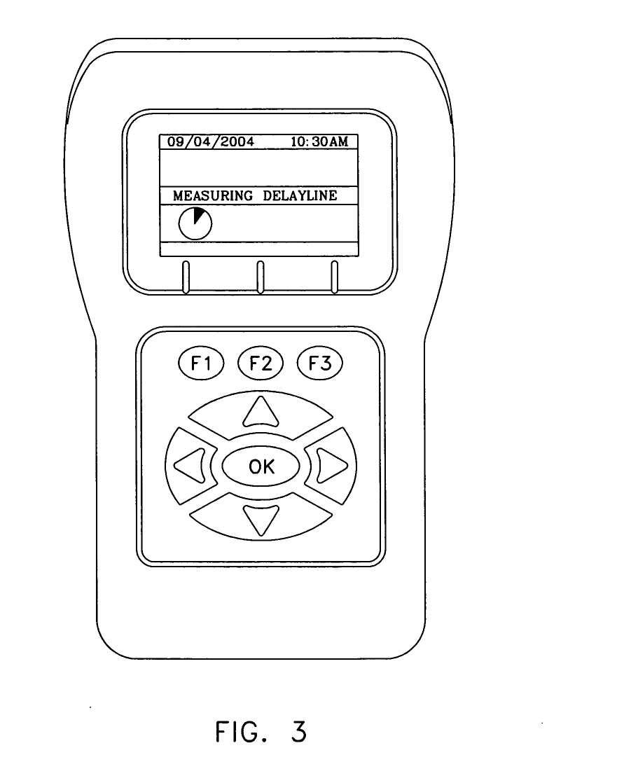

The Auto Transducer wear indicator (also sometimes referred to as the transducer attendant) is used on our ultrasonic devices. In this description, the Auto Transducer wear indicator is discussed in the context of an ultrasonic thickness gauge. By making ultrasonic measurements through each side of a delay material, in a dual constructed transducer or in a delay line, we can determine when a transducer is getting low in sensitivity and is not safe or reliable for thickness readings, and then automatically inform the user of the equipment of such a condition. Upon powering up the gauge or in certain screens such as the transducer selection screen, the gauge will display a percentage of transducer usage and indicate how much is remaining to make reliable readings. See FIGS. 1-3.

The Transducer Wear indicator aspect of the invention comprises the method and procedure of identifying the transducer wear, along with prompting the user appropriately with the indication of possible measurement error.

This aspect of the invention is not limited to ultrasonic transducers. This invention also covers a broad range of other transducers that are subject to wear, causing the possibility of measurement error.

The procedure is described here in the context of ultrasonic transducer usage and wear indication. But it should be appreciated that the procedure is by no means limited to an ultrasonic application.

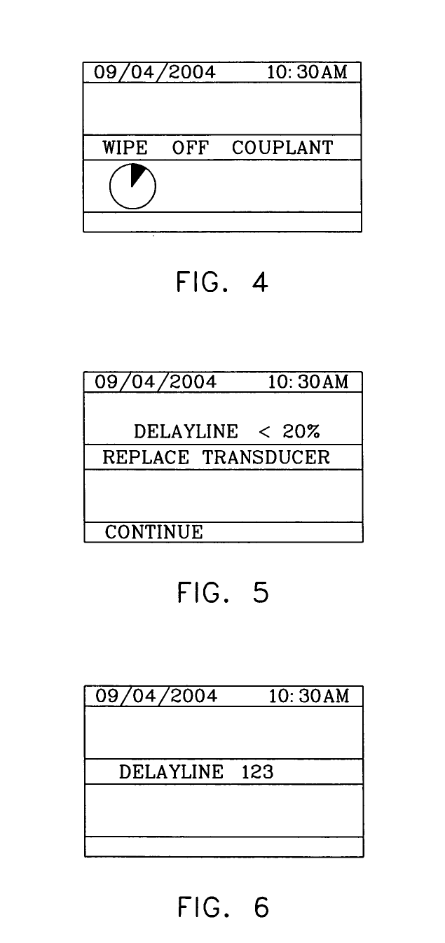

In a typical ultrasonic instrument, when the instrument is turned ON or any calibration is performed, the following user actions are required, with the user interface appearing as shown in FIG. 4.

FIG. 4 shows a user interface that prompts the user to wipe off any couplant (i.e., the fluid applied to a test piece which is necessary to transmit ultrasound into engineering type materials) that is on the surface of the transducer before calibration can be performed. Enough time is given to the user to do so.

FIG. 5 shows transducer wear indication based on the calibration performed after the user has wiped off the couplant. The FIG. 5 transducer wear alarm is only indicated when the remaining thickness of the transducer is below 20% (or any user set threshold). Also, it is important for the user to acknowledge the condition before the instrument can be used for further measurement.

FIG. 6 shows the calculated remaining transducer surface in terms of time traveled by the sound in the transducer as delay line. FIG. 6 is shown to the user if the transducer remaining surface is greater than 20% (or user set threshold) of its original thickness or once the user has acknowledged to the Transducer Wear prompt shown in FIG. 5.

This invention serves two important purposes: (a) it informs the user that it is time to change the transducer due to less than 20% (or user set threshold) of the remaining thickness; and (b) the effect of using the wear transducer can cause the accuracy of the measurement reading to be outside specification. This is particularly important in hazardous areas where minimal thickness can lead to explosions.

### (2) LED's To Light Up the Keypad on Alarm Condition

An ultrasonic thickness gauge for corroded metal is often used as a go-no-go device. As such, when a minimum thickness threshold alarm is set off, it is crucial for the operator to know of this condition. In addition to our gauge flashing the display, beeping, and vibrating, our ultrasonic device will light up the keys on the keypad as follows. Green keys indicate that the readings are above the required minimum depth threshold, while a Red keypad indicates a problem. It should be appreciated that this concept is not limited to a thickness gauge, as the ability to light up a keypad for other devices, such as detecting a flaw in an ultrasonic flaw detector, also applies. This invention is not limited to the color of the LED and/or the condition determined for alerting the user. In the simplest form of this invention, there are three “soft keys” labeled F1, F2 and F3, corresponding to the display text directly above the key. The keys will light up as follows: F1=RED (below alarm threshold), F2=YELLOW (within an operator entered percent of alarm value), and F3=GREEN (the thickness value is above the alarm condition). Here is how this feature is intended to work in one preferred implementation. The operator is making thickness readings. The operator enters an alarm minimum thickness alarm threshold of .100″ and a caution level of 20%. The operator begins to make thickness readings and the first reading is .150′ and the F3 GREEN Light is illuminated on the gauge. The operator makes a series of readings all above 0.120′ and the GREEN F3 key stays lit. Now the operator finds thinner readings in the 0.100″ to 0.120″ range and the F2 YELLOW key is illuminated (remember that we entered 20% of the alarm value so anything within 20% of .100″ will light up as a caution). Finally, the F3 RED key lights up with any reading below .100″ or the metric equivalent to all these values.

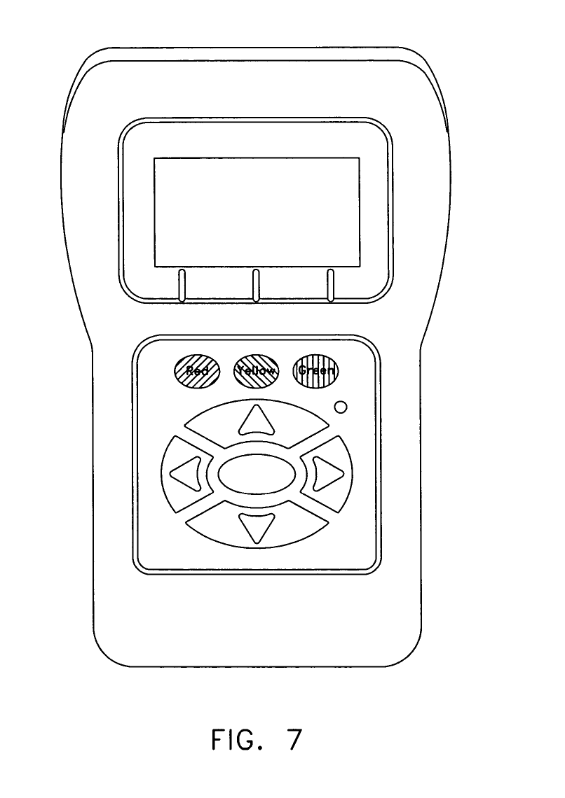

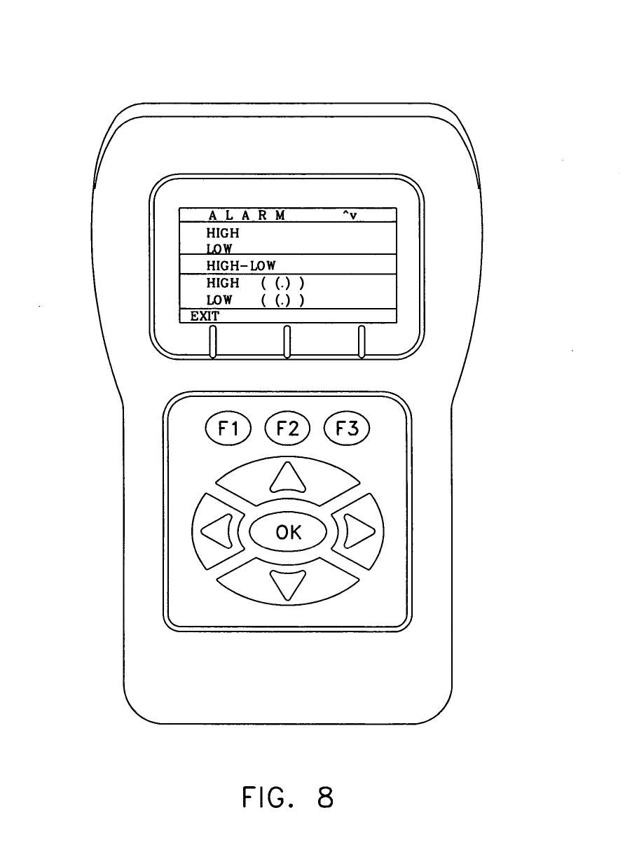

It should be appreciated that, this concept of lighting up a rubber keypad need not only apply to a thickness gauge but also has applicability to any device with similar alarm needs including, but not limited to, other ultrasonic products including flaw detectors, pulser receivers, magnetic (Hall Effect) gauges, hardness testers, alloy sorters, eddy current products, coating gauges, dimensional gauges, etc. It should also be noted that this invention also applies to color displays that can mimic what our illuminating keypad will do. Therefore, if in the future, other products use color displays, the ability to light up and change the color display will also apply. See FIGS. 7 and 8.

List of some available choices:

OFF

HIGH

LOW

HIGH-LOW

HIGH ((.))

LOW ((.))

HIGH-LOW ((.))

[OK] will allow the user to set the following parameters

HIGH 1.234 IN

LOW 0.100 IN

WARNING 20%

The LEDS light up the keypad on alarm conditions. It is also anticipated that, on alarm condition, the display back light may be turned on, and/or it is possible to simulate a lighted keypad on the color display on alarm condition.

### (3) Vibralarm to Vibrate the Ultrasonic Device on Alarm Condition

As an alternative to, or in addition to, the illuminating keypad feature described above, the thickness gauge can be set to vibrate mode for minimum or maximum thickness readings. This is particularly useful in environments where it may be difficult to recognize the lit LED's on the keypad or in an environment where it may be too loud to hear an alarm sound (e.g., a beep tone). By way of example but not limitation, these environments could be outside where the sunlight would make it difficult to see lights on an ultrasonic device or on a loud manufacturing site or construction site where the noise would make it difficult to hear the alarm.

The Vibralarm will inform the operator when a minimum or maximum value threshold has been crossed, even when they could not normally hear it with conventional techniques.

These features are not limited to a thickness gauge, it shall apply to other devices as described above such as ultrasonic flaw detectors, pulser receivers, magnetic thickness gauges, coating gauges, alloy sorters, hardness testers and eddy current products.

In one form of the invention, the ultrasonic device has the ability to alert the operator with an audible alarm, a light alarm and a vibralarm, with each alert occurring alone, simultaneously or with a combination of any of these features.

### (4) Programmable Lefty/Righty Operation

This idea allows the operator to choose if the prompts on a display corresponding to either “soft keys” or a touchscreen are to be used or controlled by the left hand or right hand. As an example, if a portable instrument which is meant to be handheld, can be used by a left handed operator or a right handed operator, the touchscreen keys can move the images of the user interface to accept a lefty or righty operator. Typically, when using portable instruments such as ultrasonic devices, voltmeters, coating gauges, hardness testers, video inspection devices, borescopes and the like, the operator usually has some other items (typically referred to generically as “the probe”) to handle. In addition, the location of the waveform or other key parameters are moved accordingly. It should be appreciated that this idea will also apply to other devices with a similar user interface.

As an example:

Lefty or left hand held datalogger where electronics are in the left hand

| SAVE | FREEZE | DIR |
|---|---|---|
| F1 | F2 | F3 |

Righty or right hand held datalogger where the electronics are in the right hand

| DIR | FREEZE | SAVE |
|---|---|---|
| F1 | F2 | F3 |

What happens here is that we switch the display corresponding to the use of the F keys or soft keys. This feature is more pronounced when using a more sophisticated device such as a portable ultrasonic flaw detector with a touchscreen display of parameters.

Modern day field instruments require the flexibility of holding the instrument in the Left hand or Right hand. The user interface is designed for a Left handed or Right handed user that is not practical for the Right hand or Left hand user, respectively. This invention describes the method and procedure of implementing a user friendly Left hand and Right hand user interface in a single instrument.

This invention is not limited to a hand-held instrument. This invention covers a broad range of instruments and user interfaces designed for ease of use for Left handed users as well as Right handed users.

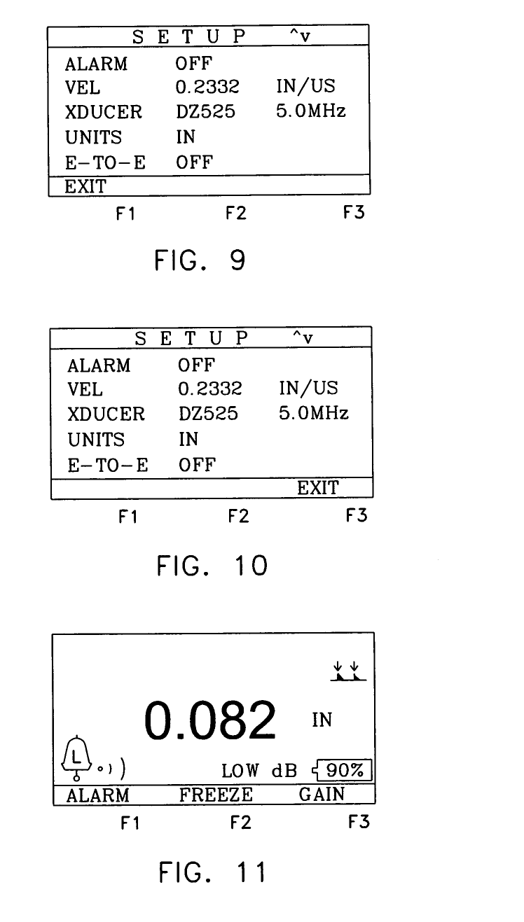

FIG. 9 shows a typical Left Hand user interface where the user holding the instrument in the left hand has easy access to the F1 function key to select “EXIT”.

FIG. 10 shows the results of the present invention with the Right Hand user interface where the user holding the instrument in the right hand has easy access to the F3 function key to select the “EXIT” operation, making it much easier than using the far end F1 function key to select “EXIT” as in FIG. 8.

FIG. 11 shows a typical Left Hand user interface where the user holding the instrument in the left hand has easy access to the F1 function key to select the “ALARM” operation used more often then the F3 function key to select “GAIN”.

FIG. 12 shows the results of the present invention with the Right Hand user interface where the user holding the instrument in the right hand has easy access to the F3 function key to select the “ALARM” operation used more often then the F1 function key to select “GAIN”.

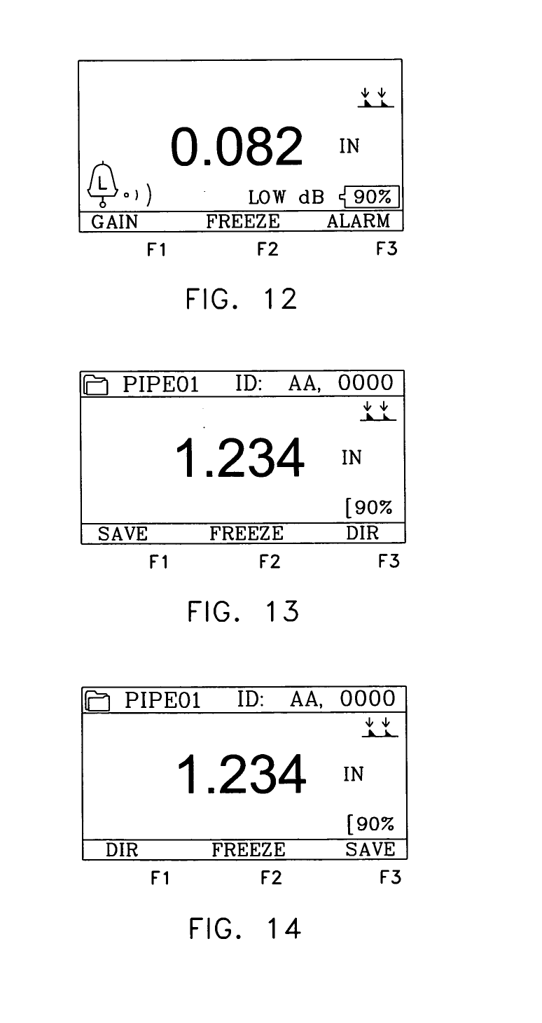

FIG. 13 shows a typical Left Hand user interface where the user holding the instrument in the left hand has easy access to the F1 function key to select the “SAVE” operation used more often then the F3 function key to select “DIR”.

FIG. 14 shows the results of the present invention with the Right Hand user interface where the user holding the instrument in the right hand has easy access to the F3 function key to select the “SAVE” operation used more often then the F1 function key to select “DIR”.

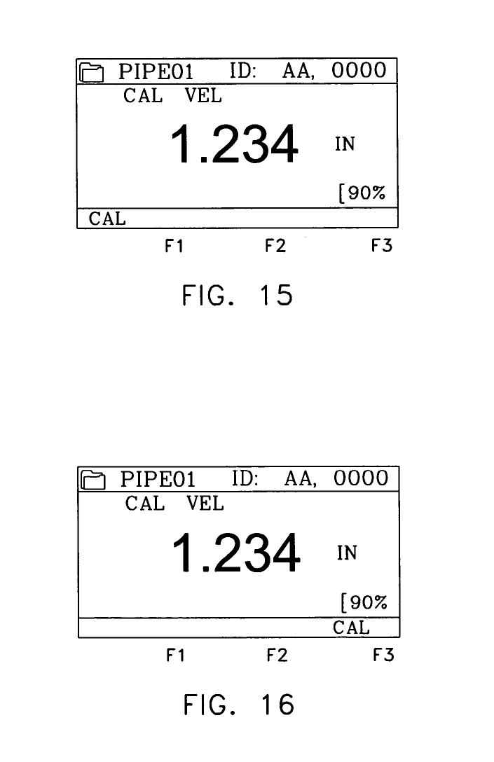

FIG. 15 shows a typical Left Hand user interface where the user holding the instrument in the left hand has easy access to the F1 function key to select the “CAL” operation.

FIG. 16 shows the results of the present invention with the Right Hand user interface where the user holding the instrument in the right hand has easy access to the F3 function key to select the “CAL” operation making it much easier than using the far end F1 function key to select “CAL” as in FIG. 14.

### ADDITIONAL CONCEPTS

(A) Lighted Transducer as Described

An optic fiber cable that connects to the instrument next to the transducer cable. The optic fiber cable is made part of the transducer cable. The tip at the transducer end of the optic fiber will show the color of the LED that is turned on/off inside the instrument. There are no electronics in the optic fiber.

The above invention allows the operator to view the alarm conditions on the head of the transducer directly. Where the operator would usually hold the transducer, the go-no-go condition is visible to the operator directly between the fingers holding the transducer, thereby the operator does not need to look at the display or the keypad every time he or she places the transducer on the test sample. This makes it fast and efficient for the operator to simply keep placing or sliding the transducer and watch the LED color change on the head of the transducer between his holding fingers, making it extremely easy and fast to test all the points without moving the head to observe the reading and the alarm condition.

(B) Lighted Transducer Cable

Using the same above optic fiber invention, the transducer cable can be made such that the multiple tips or multiple slots are created in the optic fiber to show light coming out of the cable, making the entire cable or the portion of the cable show alarm condition lighting.

Additionally, the transducer cable insulation is made of transparent material that reflects the LED color due to internal reflection on the entire surface of the cable.

In both of the above inventions, it is important to note that no electronics are in the cable or at the head of the transducer. The color LED is electronics inside the instrument.

### MODIFICATIONS

It will be appreciated that still further embodiments of the present invention will be apparent to those skilled in the art in view of the present disclosure. It is to be understood that the present invention is by no means limited to the particular constructions herein disclosed and/or shown in the drawings, but also comprises any modifications or equivalents within the scope of the invention.

What is claimed is:

1. Apparatus for measuring the thickness of a material and alerting an operator when the thickness of a material is below a certain level, the apparatus comprising:
a device for measuring the thickness of a material;
a display screen for displaying the thickness of a material to the operator; and
a device for alerting the operator when the thickness of the material is below a certain level.

2. Apparatus according to claim 1 wherein the device for alerting the operator causes the display screen to illuminate.

3. Apparatus according to claim 1 wherein the device for alerting the operator causes the apparatus to beep.

4. Apparatus according to claim 1 wherein the device for alerting the operator causes the apparatus to vibrate.

5. Apparatus according to claim 1 wherein the operator is alerted by at least one of the group consisting of an audible alarm, illuminating the apparatus and a vibration alarm.

6. Apparatus according to claim 5 wherein illuminating the apparatus comprises illuminating the display screen.

7. Apparatus according to claim 5 wherein illuminating the apparatus comprises illuminating a keypad.

8. Apparatus for measuring the thickness of a material and alerting an operator when the thickness of a material is below a certain level, the apparatus comprising:
a device for measuring the thickness of a material;
a display screen for displaying the thickness of a material to the operator; and
a device for alerting the operator when the thickness of the material is below a certain level, wherein the operator is alerted by a vibration alarm.

9. Apparatus for indicating when a transducer needs to be replaced, the apparatus comprising:
apparatus for measuring the wear of a transducer;
a display screen for displaying the wear of a transducer to the operator; and
an alarm for alerting an operator that the wear of the transducer is below a certain level, thereby indicating to the operator that the transducer needs to be replaced.

10. A handheld apparatus with a user interface which can be controlled by a left-handed or right-handed operator, the handheld apparatus comprising:
a display screen for displaying a set of parameters for an operator;
wherein, for a left-handed operator, the set of parameters are displayed on the display screen in a way that is practical for the left-handed operator and for a right-handed operator, the set of parameters are displayed on the display screen in a way that is practical for the right-handed operator.
